(19) United States
(12) Patent Application Publication
(10) Pub. No.: US 2026/0085762 A1
(43) Pub. Date: Mar. 26, 2026

(54) BIAS DOUBLE CHECK VALVE

(71) Applicant: Transportation IP Holdings, LLC, Norwalk, CT (US)

(72) Inventor: Mitchell Chase Niedrach, Greenville, SC (US)

(73) Assignee: Transportation IP Holdings, LLC, Norwalk, CT (US)

(21) Appl. No.: 18/895,164

(22) Filed: Sep. 24, 2024

(51) Int. Cl. F16K 15/04; F16K 17/04; F16K 17/06

(52) U.S. Cl. CPC F16K 15/044; F16K 17/0406; F16K 17/06; F16K 2200/201

(57) ABSTRACT

A bias double check valve is provided to receive a pressurized medium at a supply port from a pressurized system. The bias double check valve comprises a first check valve configured to regulate the pressure of a delivery port, and a second check valve configured to relieve pressure of the delivery port. The first check valve further comprises a biasing spring that may be adjusted to achieve a predetermined pressure value in the delivery port. The first check valve and the second check valve are integrated into a single housing allowing the bias double check valve to be easily integrated and replaced in the pressurized system.

### TECHNICAL FIELD

The subject matter described herein relates to a bias double check valve system where a first check valve and a second check valve are integrated into a single housing.

### SUMMARY

In one embodiment, the present invention describes a double valve, comprising: a housing defining a supply port and a delivery port; the delivery port configured to output a pressurized medium supplied through the supply port; a first check valve extending between the supply port and the delivery port, wherein the first check valve is transitionable between a first open configuration and a first closed configuration; a second check valve extending between the supply port and the delivery port, wherein the second check valve is transitionable between a second open configuration and a second closed configuration; and wherein the first check valve and the second check valve are configured to maintain the first open configuration and the second closed configuration based on a supply pressure by the pressurized medium in the supply port; wherein the first check valve is configured to transition to the first closed configuration based on the supply pressure reaching a predetermined pressure threshold; and wherein the second check valve is configured to transition to the second open configuration based on a delivery pressure by the pressurized medium in the delivery port exceeding the supply pressure.

In another embodiment, the present invention describes a method for regulating pressure comprising: receiving a pressurized medium in a supply port; exerting, by the pressurized medium, a first force on a first backflow stopper in a first check valve; exerting, by the pressurized medium, the first force on a second backflow stopper in a second check valve, wherein the first force is a supply pressure of the pressurized medium in the supply port; transitioning the first check valve to a first open position by the pressurized medium, wherein the first force is greater than a resultant force exerted on the first backflow stopper, and wherein the pressurized medium passes through a first passage of the first check valve to a delivery port; and transitioning the second check valve to a second closed position by the pressurized medium, wherein the first force exerted on the second backflow stopper is greater than a second force exerted on the second backflow stopper, wherein the second force is a back flow pressure of the pressurized medium in the delivery port toward the supply port.

In yet another embodiment, the present invention describes a double valve, comprising: a unitary valve body, wherein the valve body defines a supply port and a delivery port configured to output a pressurized medium supplied through the supply port; a first check valve in the valve body and extending between the supply port and the delivery port, wherein the first check valve is transitionable between a first open configuration and a first closed configuration; and a second check valve in the valve body and extending between the supply port and the delivery port, wherein the second check valve is transitionable between a second open configuration and a second closed configuration; wherein the first check valve and the second check valve are configured to maintain the first open configuration and the second closed configuration based on a supply pressure by the pressurized medium in the supply port; wherein the first check valve is configured to transition to the first closed configuration based on the supply pressure reaching a predetermined pressure threshold; and wherein the second check valve is configured to transition to the second open configuration based on a delivery pressure by the pressurized medium in the delivery port exceeding the supply pressure.

### BRIEF DESCRIPTION OF THE DRAWINGS

The subject matter may be understood from reading the following description of non-limiting embodiments, with reference to the attached drawings, wherein below:

FIG. 1 shows a cross-sectional view of a bias double check valve in an integrated housing, coupled to a supply line and a delivery line of a pressurized system, according to at least one aspect of the present disclosure.

FIG. 2 shows a cross-sectional view of a bias double check valve, integrated in a housing, and coupled to a supply line and a delivery line of a pressurized system, according to at least one aspect of the present disclosure.

FIG. 3 shows a cross-sectional view of a bias double check valve including a first check valve in an opened and a second check valve in a closed position, according to at least one aspect of the present disclosure.

FIG. 4 shows a cross-sectional view of a bias double check valve including a first check valve in a closed position and a second check valve in a closed position, according to at least one aspect of the present disclosure.

FIG. 5 shows a cross-sectional view of a bias double check valve including a first check valve in a closed position and a second check valve in an opened position, according to at least one aspect of the present disclosure.

FIG. 6 is a logic flow diagram for regulating the pressure of a pressurized medium through a double check valve in a pressurized system, according to at least one aspect of the present disclosure.

FIG. 7 is a logic flow diagram for relieving the pressure of a pressurized medium through a double check valve in a pressurized system, according to at least one aspect of the present disclosure.

### DETAILED DESCRIPTION

The present disclosure describes a bias double check valve integrated, including a first check valve and a second check valve, into a single housing. The first check valve may regulate a pressure flow of a pressurized medium from a supply port to the delivery port. The first check valve further comprises a bias spring to allow a predetermined amount of a pressure to overcome a biasing force and allow a pressurized medium to pass from the supply port to the delivery port. The second check valve may relieve the pressure of the delivery port in a predetermined pressure condition. The integrated housing allows for seamless integration into the existing conduits or pipe structure of an existing pressurized system and may be easily replaced for maintenance with a new check valve. Overtime, the components of the bias double check valve may experience wear and need to be replaced. Accordingly, the integrated design allows for a simple replacement with a new or rebuilt unit, as part of routine maintenance.

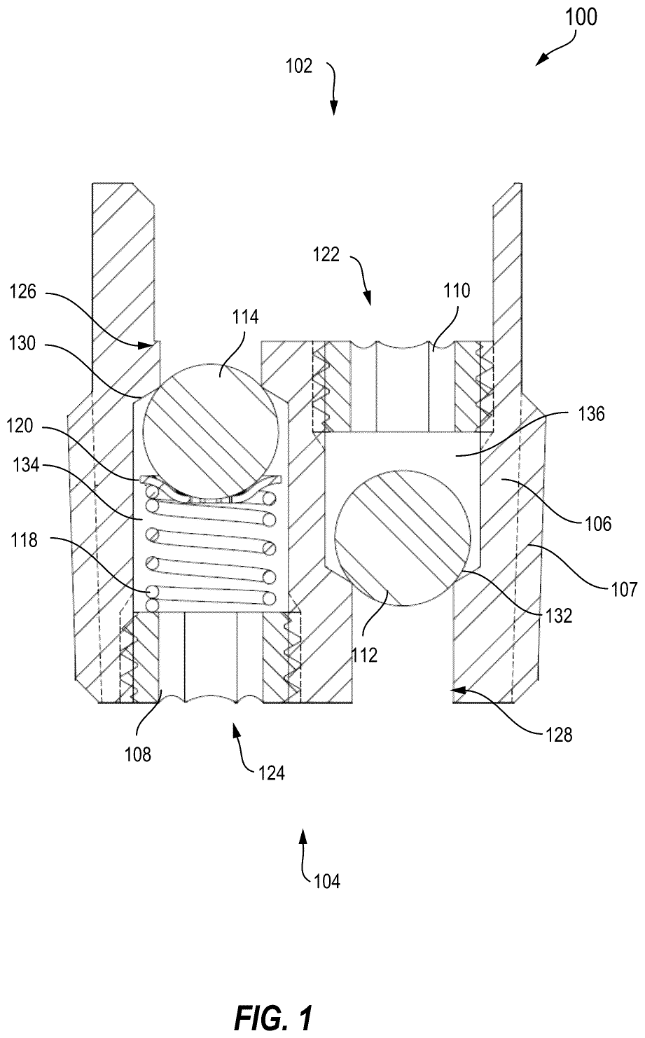

FIG. 1 shows a cross-sectional view of a bias double check valve 100, integrated in a housing 106, and coupled to a supply line and a delivery line of a pressurized system, according to at least one aspect of the present disclosure. The bias double check valve 100 comprises a first check valve 124 and a second check valve 122. The first check value comprises a first backflow stopper 114, a seating ring 120, a bias spring 118, and an adjustable bias screw 108. The first backflow stopper may form an airtight seal along a first edge 130 of the first check valve. The first edge transitions from a first diameter of a first check valve passage 134 to a second diameter at a first inlet 126. The first inlet has a diameter that is smaller than the diameter of the first backflow stopper and the first check valve passage.

The second check valve comprises a second backflow stopper 112 and a sealing screw 110. The sealing screw may be used for maintenance to replace and rebuild the second backflow stopper in the second check valve. The second backflow stopper may form an airtight seal along a second edge 132 of the second check valve. The second edge transitions from a diameter of a second check valve passage 136 to a diameter at a second inlet 128. The second inlet has a smaller diameter than the diameter of the second backflow stopper and the second check valve passage.

The bias double check valve 100 receives a pressurized medium through a supply port 102 and a portion of the pressurized medium may pass through the first check valve, when it is in an open position, into a delivery port 104. A pressurized system may be coupled to the supply port and the delivery port through an airtight treaded portion. The exterior surface 107 of the housing may comprise threads that engage with an interior portion of a pipe of the pressurized system. The exterior threaded surface allows the bias double check valve to be easily replaced for maintenance.

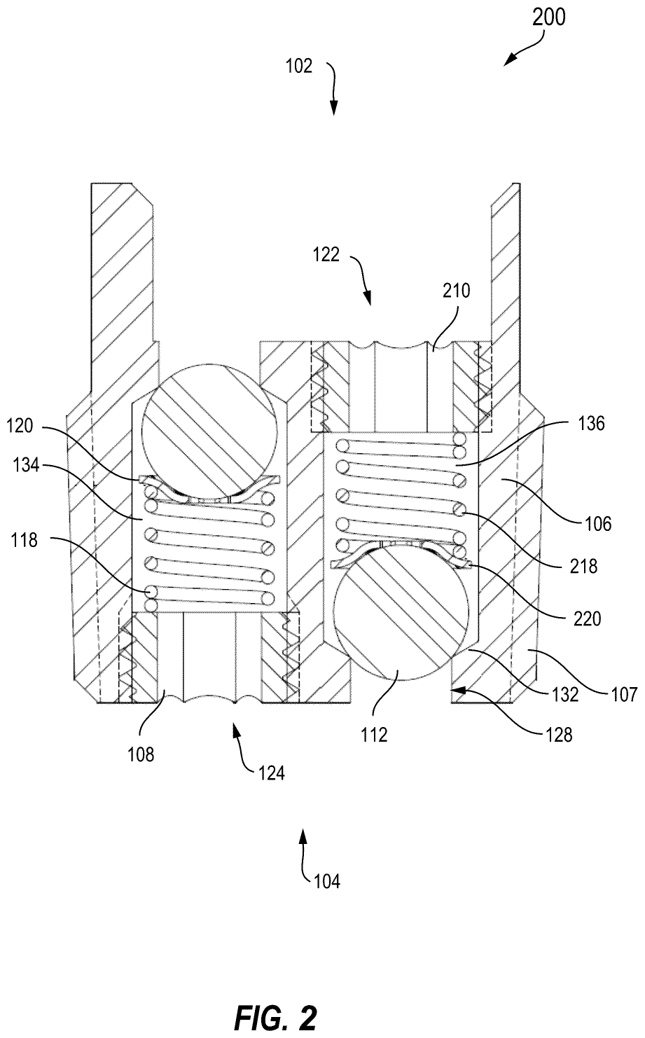

FIG. 2 shows a cross-sectional view of a bias double check valve 200, integrated in a housing 106, and coupled to a supply line and a delivery line of a pressurized system, according to at least one aspect of the present disclosure. The bias double check valve 200 comprises a first check valve 124 and a second check valve 122. The first check value comprises a first backflow stopper 114, a seating ring 120, a bias spring 118, and an adjustable bias screw 108. The second check valve comprises a second backflow stopper 112, a second seating ring 220, a second bias spring 218, and a second adjustable bias screw 210. The second backflow stopper may form an airtight seal along a second edge 132 of the second check valve. The second edge transitions from a diameter of a second check valve passage 136 to a diameter at a second inlet 128. The second inlet has a smaller diameter than the diameter of the second backflow stopper and the second check valve passage.

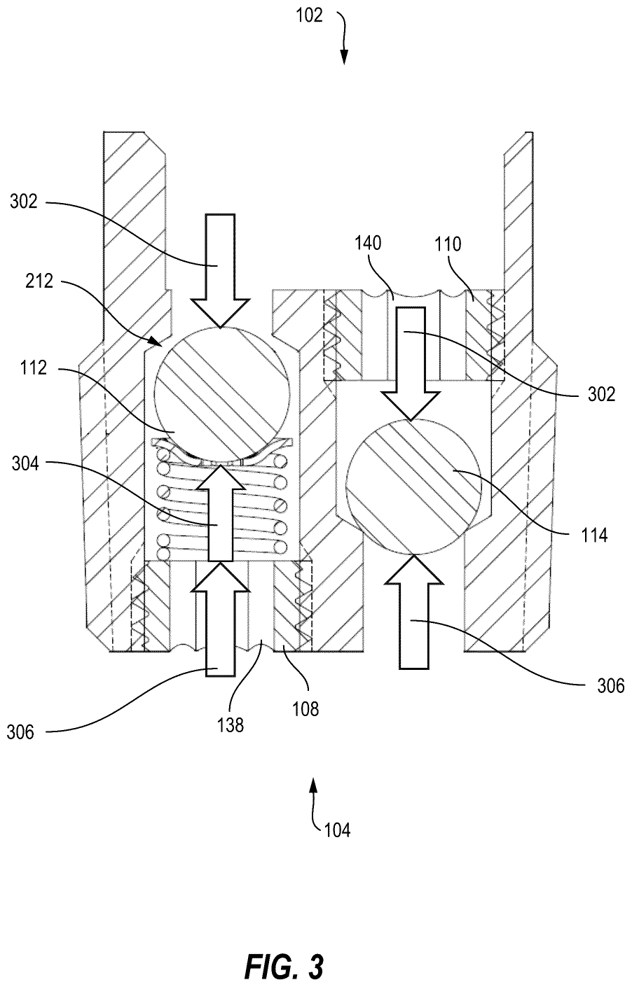

FIG. 3 shows a cross-sectional view of a bias double check valve including a first check valve in an opened position and a second check valve in a closed position, according to at least one aspect of the present disclosure. The bias double check valve may be connected to a pressurized system at the supply port. The pressurized system may provide a pressurized medium to the supply port, where the pressurized medium exerts a first force 302 on the first backflow stopper and the second backflow stopper. The bias spring may exert a biasing force 304 on the first backflow stopper in the opposite direction as the first force. A resultant force may be produced by the combination of the biasing force and a second force 306 produced by a pressured medium in the delivery port. The resultant force may be exerted on the first backflow stopper in the opposing direction of the first force.

In one example, the first force produced by the pressurized medium is greater than the resultant force. The first force compresses the bias spring and causes the first check valve to transition from a closed position to an open position. FIG. 3 shows a space between the backflow stopper and the edge that allows the pressurized medium to flow from the supply port, through the check valve passage, and into the delivery port. The first check valve acts as a pressure regulator by only allowing a portion of the pressurized medium to pass to the delivery port. The pressure in the delivery port may be regulated by adjusting the adjustable bias screw or replacing the bias spring with different spring constant. The position of the adjustable bias screw may determine the amount of force exerted by the bias spring on to the first backflow stopper. Additionally, the pressure regulation function prevents excessive wear on down stream components.

Once the pressurized medium reaches the delivery port, it may flow to a downstream system or be temporarily stored in the delivery port. When the pressurized medium is not released from a downstream system or is released at a rate that is less than the incoming rate, a back pressure is created in the delivery port. The back pressure is exerted on the first backflow stopper and the second backflow stopper as the second force. The adjustable bias screw includes a hollow center 138 to allow the back pressure to flow into the first check valve and create the resultant force on the first backflow stopper.

FIG. 3 further shows the back pressure acting on the second backflow stopper. When the first check valve is in the open position, the second check valve will be in the closed position because the first force needs to be greater than the second force to overcome the bias force and open the first check valve. The first force is exerted on the second backflow stopper to create a seal between the second backflow stopper and the second edge, resulting in the second check valve in the closed position.

The sealing screw of the second check valve further comprises a hollow center 140 to allow the pressurized medium to pass through the sealing screw and exert the first force on the second backflow stopper. The sealing screw may be used to keep the backflow stopper in the second check valve during use. The sealing screw allows the second backflow stopper to be removed during periodic maintenance and rebuilding the bias double check valve.

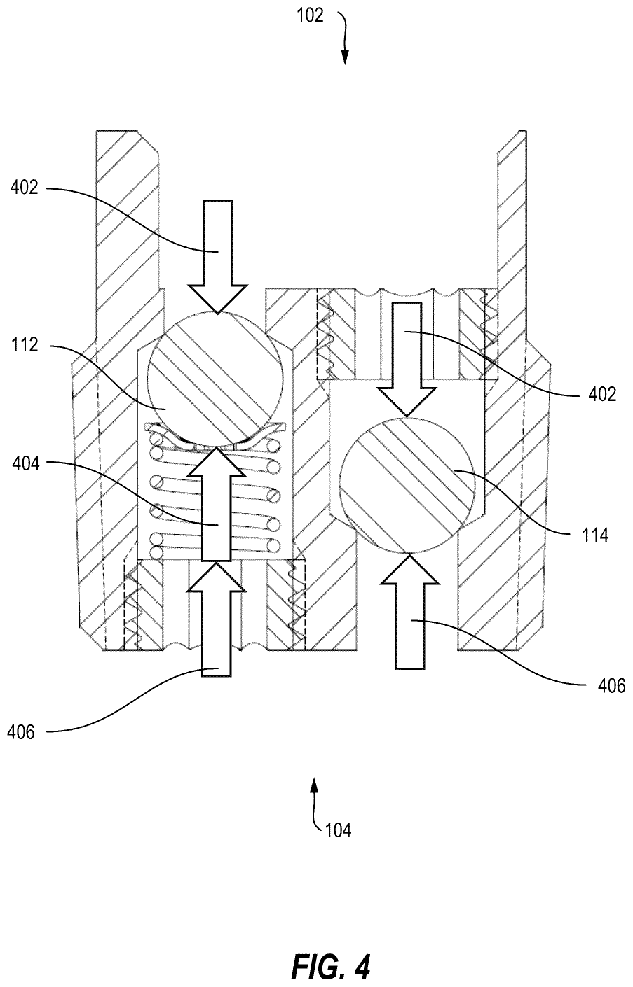

FIG. 4 shows a cross-sectional view of the bias double check valve including a first check valve in a closed position and a second check valve in a closed position, according to at least one aspect of the present disclosure. In this example, the first force 402 produced by the pressurized medium in the supply port is greater than the back pressure produced in the delivery port, but the first force is less than or equal to the resultant force of the biasing force 404 and the second force 406. As a result, the first force is insufficient to overcome the resultant force produced by the bias spring force and the second force in the first check valve but is sufficient to keep the second check valve in the closed position, and the first check valve and the second check valve are in the closed position.

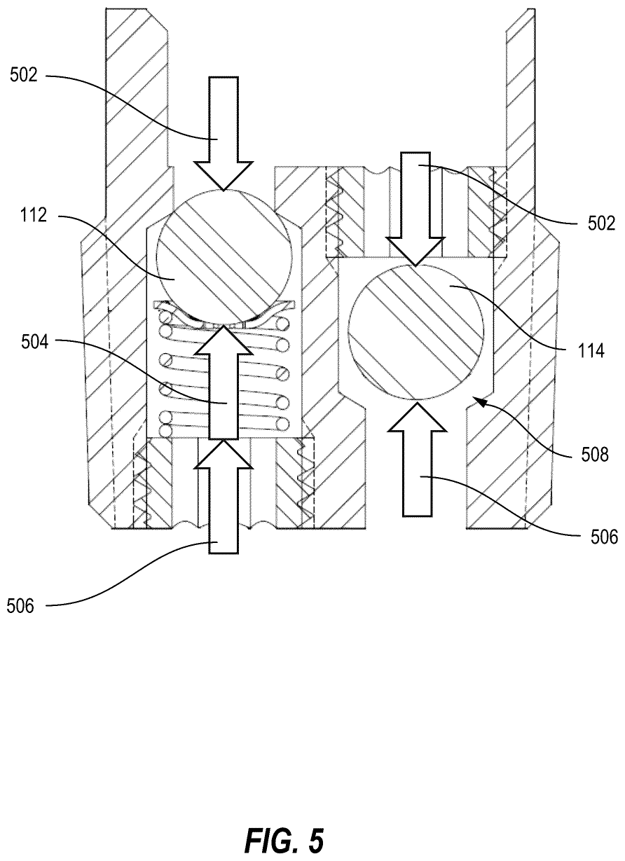

FIG. 5 shows a cross-sectional view of the bias double check valve including the first check valve in a closed position and the second check valve in an opened position, according to at least one aspect of the present disclosure. In this example, the first force 502 produced by the pressurized medium in the supply port, or lack thereof, is less than or equal to the second force produced by the back pressure in the delivery port. As a result, the first force is insufficient to overcome the resultant force of the biasing force 504 and second force and keeps the first check valve close. However, the second force exerted on the second backflow stopper is sufficient to overcome the opposing first force and place the second check valve in an opened position 408. The opened position creates space between the second backflow stopper and the second edge to allow the pressurized medium to be released or purged when there is a decrease in pressure in the supply port. This situation occurs when the delivery port is pressurized to a determined level based on the pressure regulation of the first check valve and then the pressure on the supply port is released. The second check valve acts as a relief valve to change the operational state of downstream components. This may occur after an air brake is engaged, the vehicle comes to rest and the supply pressure release.

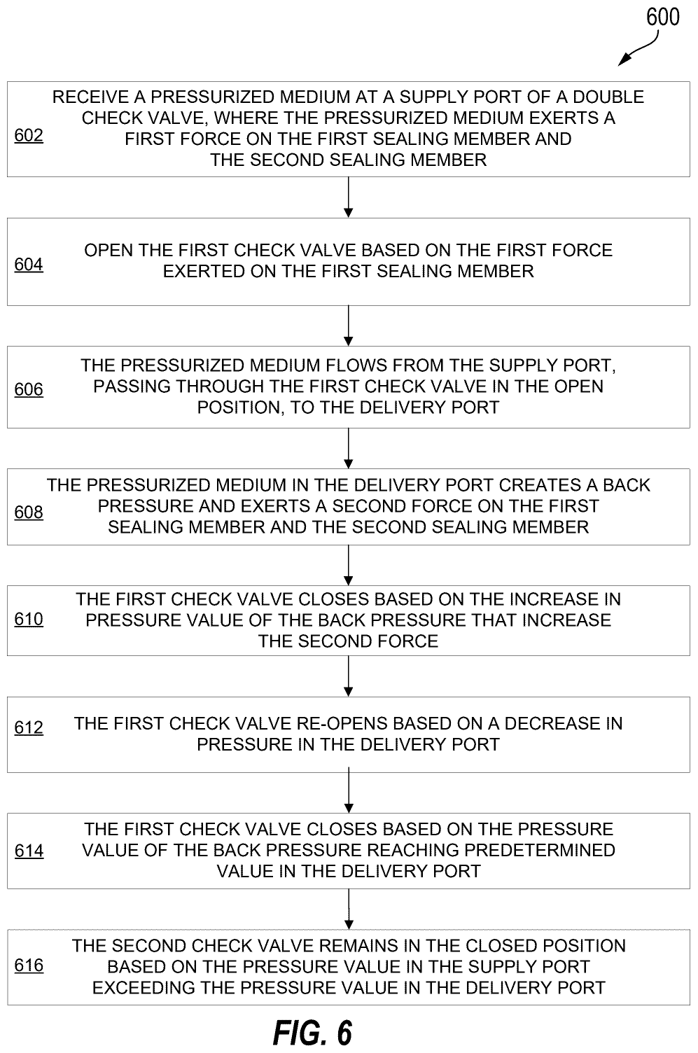

FIG. 6 is a logic flow diagram representing a method 600 for regulating the pressure of a pressurized medium through a bias double check valve in a pressurized system, according to at least one aspect of the present disclosure. The bias double check valve receives 602 a pressurized medium at a supply port valve and the pressurized medium exerts a first force on a first backflow stopper of the first check valve and the second backflow stopper of the second check valve. The first check valve opens 604 based on the first force exerted on the first backflow stopper of the first check valve and the second check valve remains closed based on the first force exerted on the second backflow stopper of the second check valve. The first check valve allows the pressurized medium to pass 606 through the open check valve and pressurizes the delivery port of the bias double check valve. The first check valve opens based on the first force exerting a greater force than a resultant force produced by a bias spring and a back pressure. The pressurized medium produces 608 the back pressure in the delivery port and exerts a second force on the first backflow stopper and the second backflow stopper in the opposing direction of the first force. The bias spring produces a biasing force on the first backflow stopper in the opposing direction of the first force. As the pressurized medium flows from the supply port to the delivery port, the back pressure in the deliver port increases until the first force can no longer maintain the first check valve in the open position. The first check valve closes 610 based on the resultant force being greater than or equal to the first force.

In one example, a downstream system from the delivery port is activated and the back pressure in the delivery port is reduced. The pressure reduction in the delivery port decreases the second force and causes the first check valve to reopen 612 until the resultant force is greater than or equal to the first force. The biasing force produced by the bias spring helps to regulate the pressure between the supply port and the delivery port. In various aspects, as the biasing force is increased the greater the pressure is reduced from the supply port to the delivery port. The biasing force may be calibrated based on the spring constant of the biasing spring and the position of the adjustable bias screw. The first check value closes 614 based on the back pressure in the delivery port reaching a predetermined pressure value. The second check valve remains in the closed position when the pressure value in the supply port is greater than the pressure value of the delivery port.

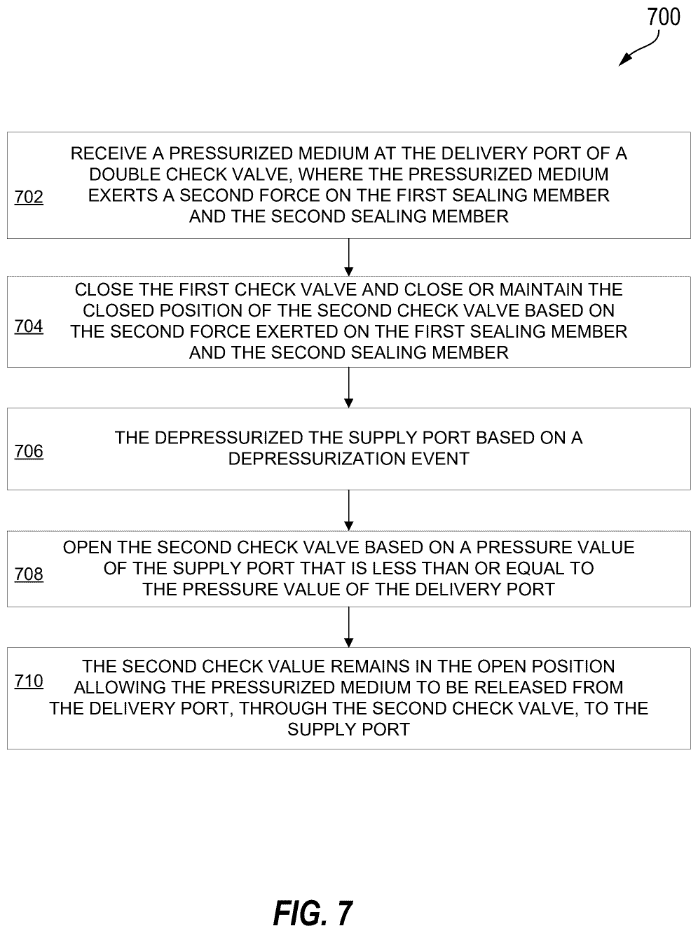

FIG. 7 is a logic flow diagram of a method 700 for relieving the pressure of a pressurized medium through a bias double check valve in a pressurized system, according to at least one aspect of the present disclosure. The supply port and the delivery port pressurize 702 with a pressurized medium, where the first check valve and the second check valve are in the closed position 704. The supply port depressurizes 706 by a depressurization event, resulting in the reduction of the pressure value of the pressurized medium in the supply port. The change in pressure causes the first force exerted on the second backflow stopper to the be less than the second force exerted on the second backflow stopper in the second check valve. The second check valve enters the open position 708 allowing the pressurized medium in the delivery port to pass through the second check valve. The second check valve remains 710 in the open while the pressure value in the delivery port is greater than or equal to the pressure value of the supply port.

Examples of the method, system, and/or apparatus disclosed herein, according to various embodiments of the present disclosure, are provided below in the following embodiments. An embodiment of the method, system, and/or apparatus may include any one or more than one of, and any combination of, the embodiments described below.

In a first embodiment, the present disclosure provides a double valve, comprising: a housing defining a supply port and a delivery port; the delivery port configured to output a pressurized medium supplied through the supply port; a first check valve extending between the supply port and the delivery port, wherein the first check valve is transitionable between a first open configuration and a first closed configuration; a second check valve extending between the supply port and the delivery port, wherein the second check valve is transitionable between a second open configuration and a second closed configuration; and wherein the first check valve and the second check valve are configured to maintain the first open configuration and the second closed configuration based on a supply pressure by the pressurized medium in the supply port; wherein the first check valve is configured to transition to the first closed configuration based on the supply pressure reaching a predetermined pressure threshold; and wherein the second check valve is configured to transition to the second open configuration based on a delivery pressure by the pressurized medium in the delivery port exceeding the supply pressure.

Additionally, the first embodiment, wherein the first check valve is a biased check valve and the second check valve is an unbiased check valve, and wherein the biased check valve is configured to resist backflow of the pressurized medium toward the supply port, and wherein the unbiased check valve is configured to relieve an excess buildup of the delivery pressure.

Alternatively, the first embodiment, wherein the first check valve comprises: a first valve body defining a first check valve passage; and a backflow stopper movable within the first check valve passage to transition the first check valve between the first open configuration and the first closed configuration, wherein the backflow stopper is configured to permit forward flow of the pressurized medium toward the delivery port in the first open configuration, and configured to resist backflow toward the supply port in the first closed configuration, wherein the second check valve comprises a second valve body defining a second check valve passage, wherein the supply port branches into the first check valve passage and the second check valve passage, and wherein the first check valve passage and the second check valve passage branch out to the delivery port, wherein the second check valve further comprises a pressure relief structure movable within the second check valve passage to transition the second check valve between the second open configuration and the second closed configuration, and wherein either: the pressure relief structure is configured to permit back flow of the pressurized medium toward the supply port in the second open configuration, or the pressure relief structure is configured to prevent forward flow from the second check valve passage toward the delivery port in the second closed configuration.

Alternatively, the first embodiment, wherein the first check valve further comprises a bias spring exerting a biasing force on the backflow stopper, wherein the predetermined pressure threshold is based on the biasing force, wherein the first check valve further comprises a first adjustable screw configurable to modify the biasing force exerted on the backflow stopper by the bias spring, wherein the second check valve comprises a second adjustable screw, and wherein each of the first adjustable screw and the second adjustable screw comprises a respective hollow center, wherein the first adjustable screw comprises a first screw head accessible from the delivery port, wherein the second adjustable screw comprises a second screw head accessible from the supply port, and wherein the second check valve is configured to purge the pressurized medium from the delivery port to the supply port through a second check valve passage until the second check valve is closed.

Alternatively, the first embodiment, wherein the second check valve further comprises a second bias spring exerting a second biasing force on the second backflow stopper, wherein the predetermined pressure threshold is based on the second biasing force.

In a second embodiment, the present disclosure provides a method for regulating pressure comprising: receiving a pressurized medium in a supply port; exerting, by the pressurized medium, a first force on a first backflow stopper in a first check valve; exerting, by the pressurized medium, the first force on a second backflow stopper in a second check valve, wherein the first force is a supply pressure of the pressurized medium in the supply port; transitioning the first check valve to a first open position by the pressurized medium, wherein the first force is greater than a resultant force exerted on the first backflow stopper, and wherein the pressurized medium passes through a first passage of the first check valve to a delivery port; and transitioning the second check valve to a second closed position by the pressurized medium, wherein the first force exerted on the second backflow stopper is greater than a second force exerted on the second backflow stopper, wherein the second force is a back flow pressure of the pressurized medium in the delivery port toward the supply port.

Additionally, the first embodiment, wherein the first check valve and the second check valve are integrated a single housing; the second check valve comprises a second passage, the supply port branches into the first passage and the second passage, and the first passage and the second passage branch out to the delivery port; the first passage of the first check valve is parallel to the second passage of the second check valve.

Alternatively, the first embodiment, wherein the first check valve comprises a bias spring configured to exert a biasing force on the first backflow stopper, and wherein the resultant force comprises the biasing force and the second force, and wherein the first force and the resultant force are directionally opposed, and wherein the first force and the second force are directionally opposed, and wherein the first embodiment is further comprising, transitioning the first check valve to a first closed position by the resultant force, wherein the first force is less than the resultant force exerted on the first backflow stopper, and wherein the second force is exerted on the first backflow stopper by the pressurized medium in the delivery port; and transitioning the second check valve to a second open position by the second force, wherein the second force is greater than or equal to the first force, wherein the second force is exerted on the second backflow stopper by the pressurized medium in the delivery port, and wherein the pressurized medium passes through a second passage of the second check valve to the supply port.

In a third embodiment, the present disclosure provides a double valve, comprising: a unitary valve body, wherein the valve body defines a supply port and a delivery port configured to output a pressurized medium supplied through the supply port; a first check valve in the valve body and extending between the supply port and the delivery port, wherein the first check valve is transitionable between a first open configuration and a first closed configuration; and a second check valve in the valve body and extending between the supply port and the delivery port, wherein the second check valve is transitionable between a second open configuration and a second closed configuration; wherein the first check valve and the second check valve are configured to maintain the first open configuration and the second closed configuration based on a supply pressure by the pressurized medium in the supply port; wherein the first check valve is configured to transition to the first closed configuration based on the supply pressure reaching a predetermined pressure threshold; and wherein the second check valve is configured to transition to the second open configuration based on a delivery pressure by the pressurized medium in the delivery port exceeding the supply pressure.

The foregoing detailed description has set forth various forms of the systems and/or processes via the use of block diagrams, flowcharts, and/or examples. Unless specifically stated otherwise as apparent from the foregoing disclosure, it is appreciated that, throughout the present disclosure, discussions using terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

One or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc. ” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc. ” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flow diagrams are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

As used herein, the singular form of “a”, “an”, and “the” include the plural references unless the context clearly dictates otherwise.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material. None is admitted to be prior art.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

What is claimed is:

1. A double valve, comprising:
a housing defining a supply port and a delivery port;
the delivery port configured to output a pressurized medium supplied through the supply port;
a first check valve extending between the supply port and the delivery port, wherein the first check valve is transitionable between a first open configuration and a first closed configuration;
a second check valve extending between the supply port and the delivery port, wherein the second check valve is transitionable between a second open configuration and a second closed configuration; and
wherein the first check valve and the second check valve are configured to maintain the first open configuration and the second closed configuration based on a supply pressure by the pressurized medium in the supply port;
wherein the first check valve is configured to transition to the first closed configuration based on the supply pressure reaching a predetermined pressure threshold; and
wherein the second check valve is configured to transition to the second open configuration based on a delivery pressure by the pressurized medium in the delivery port exceeding the supply pressure.

2. The double valve of claim 1, wherein the first check valve is a biased check valve and the second check valve is an unbiased check valve.

3. The double valve of claim 2, wherein the biased check valve is configured to resist backflow of the pressurized medium toward the supply port, and wherein the unbiased check valve is configured to relieve an excess buildup of the delivery pressure.

4. The double valve of claim 1, wherein the first check valve comprises:
a first valve body defining a first check valve passage; and
a backflow stopper movable within the first check valve passage to transition the first check valve between the first open configuration and the first closed configuration, wherein the backflow stopper is configured to permit forward flow of the pressurized medium toward the delivery port in the first open configuration, and configured to resist backflow toward the supply port in the first closed configuration.

5. The double valve of claim 4, wherein the second check valve comprises a second valve body defining a second check valve passage, wherein the supply port branches into the first check valve passage and the second check valve passage, and wherein the first check valve passage and the second check valve passage branch out to the delivery port.

6. The double valve of claim 5, wherein the second check valve further comprises a pressure relief structure movable within the second check valve passage to transition the second check valve between the second open configuration and the second closed configuration.

7. The double valve of claim 6, wherein the pressure relief structure is configured to permit back flow of the pressurized medium toward the supply port in the second open configuration.

8. The double valve of claim 6, wherein the pressure relief structure is configured to prevent forward flow from the second check valve passage toward the delivery port in the second closed configuration.

9. The double valve of claim 4, wherein the first check valve further comprises a bias spring exerting a biasing force on the backflow stopper, wherein the predetermined pressure threshold is based on the biasing force.

10. The double valve of claim 9, wherein the first check valve further comprises a first adjustable screw configurable to modify the biasing force exerted on the backflow stopper by the bias spring.

11. The double valve of claim 10, wherein the second check valve comprises a second adjustable screw, and wherein each of the first adjustable screw and the second adjustable screw comprises a respective hollow center.

12. The double valve of claim 11, wherein the first adjustable screw comprises a first screw head accessible from the delivery port, and wherein the second adjustable screw comprises a second screw head accessible from the supply port.

13. The double valve of claim 12, wherein the second check valve is configured to purge the pressurized medium from the delivery port to the supply port through a second check valve passage until the second check valve is closed.

14. The double valve of claim 4, wherein the second check valve further comprises a second bias spring exerting a second biasing force on the second backflow stopper, wherein the predetermined pressure threshold is based on the second biasing force.

15. A method for regulating pressure comprising:
receiving a pressurized medium in a supply port;
exerting, by the pressurized medium, a first force on a first backflow stopper in a first check valve;
exerting, by the pressurized medium, the first force on a second backflow stopper in a second check valve, wherein the first force is a supply pressure of the pressurized medium in the supply port;
transitioning the first check valve to a first open position by the pressurized medium, wherein the first force is greater than a resultant force exerted on the first backflow stopper, and wherein the pressurized medium passes through a first passage of the first check valve to a delivery port; and
transitioning the second check valve to a second closed position by the pressurized medium, wherein the first force exerted on the second backflow stopper is greater than a second force exerted on the second backflow stopper, wherein the second force is a back flow pressure of the pressurized medium in the delivery port toward the supply port.

16. The method of claim 15, wherein:
the first check valve and the second check valve are integrated a single housing;
the second check valve comprises a second passage, the supply port branches into the first passage and the second passage, and the first passage and the second passage branch out to the delivery port;
the first passage of the first check valve is parallel to the second passage of the second check valve.

17. The method of claim 15, wherein the first check valve comprises a bias spring configured to exert a biasing force on the first backflow stopper, and wherein the resultant force comprises the biasing force and the second force, and wherein the first force and the resultant force are directionally opposed, and wherein the first force and the second force are directionally opposed.

18. The method of claim 17, further comprising:
transitioning the first check valve to a first closed position by the resultant force, wherein the first force is less than the resultant force exerted on the first backflow stopper, and wherein the second force is exerted on the first backflow stopper by the pressurized medium in the delivery port.

19. The method of claim 18, further comprising:
transitioning the second check valve to a second open position by the second force, wherein the second force is greater than or equal to the first force, wherein the second force is exerted on the second backflow stopper by the pressurized medium in the delivery port, and wherein the pressurized medium passes through a second passage of the second check valve to the supply port.

20. A double valve, comprising:
a unitary valve body, wherein the valve body defines a supply port and a delivery port configured to output a pressurized medium supplied through the supply port;
a first check valve in the valve body and extending between the supply port and the delivery port, wherein the first check valve is transitionable between a first open configuration and a first closed configuration; and
a second check valve in the valve body and extending between the supply port and the delivery port, wherein the second check valve is transitionable between a second open configuration and a second closed configuration;
wherein the first check valve and the second check valve are configured to maintain the first open configuration and the second closed configuration based on a supply pressure by the pressurized medium in the supply port;
wherein the first check valve is configured to transition to the first closed configuration based on the supply pressure reaching a predetermined pressure threshold; and
wherein the second check valve is configured to transition to the second open configuration based on a delivery pressure by the pressurized medium in the delivery port exceeding the supply pressure.
